(19) United States
(12) Patent Application Publication
(10) Pub. No.: US 2011/0074831 A1
(43) Pub. Date: Mar. 31, 2011

(54) SYSTEM AND METHOD FOR DISPLAY NAVIGATION

(75) Inventors: Stephen Lynch, New York, NY (US); Brett Dovman, New York, NY (US); Wade Slitkin, New York, NY (US); Michael Margolis, San Francisco, CA (US); Aaron Haney, Santa Clara, CA (US); Jules Janssen, Maastricht (NL)

(73) Assignee: Opsis Distribution, LLC, New York, NY (US)

(21) Appl. No.: 12/731,738

(22) Filed: Mar. 25, 2010

Related U.S. Application Data
(60) Provisional application No. 61/166,099, filed on Apr. 2, 2009.

(51) Int. Cl. G09G 5/00

(52) U.S. Cl. 345/682

(57) ABSTRACT

A system and method for navigating pages of content on a target device is disclosed. The target device has a display area that is typically smaller than a page of content. Rather than having the user use scroll bars or finger gestures to view the entire page, a predetermined sequence of frames are displayed to the user. A frame is a preselected portion of a page. The user simply indicates when he has completed reading or viewing the current frame, and the next frame is then presented in the display area. This predetermined sequence is generated by the content provider or author, who uploads both the content and the frame sequence to a server, where it can be accessed by potential users.

This application claims priority of U.S. Provisional Patent Application Ser. No. 61/166,099, filed Apr. 2, 2009, the disclosure of which is herein incorporated by reference in its entirety.

### BACKGROUND OF THE INVENTION

Since the advent of the computer monitor, the search to find the best method to display information to the user has been ongoing. Originally, a computer screen had a predetermined height and width, so information exceeding the visible display area was simply lost.

Later, the concept of scroll bars gained popularity. In typical configurations, a scroll area 110 is located on the right side of the display area 100, as shown in FIG. 1. In many embodiments, the scroll area shows two important pieces of information. The scroll area 110 is typically made up of an upward facing arrow 111, a downward facing arrow 112, and a scroll bar 115. The size of the scroll bar 115 as a percentage of the scroll area 110 represents the percentage of the total image that is viewable. In other words, if, as is shown in this example, the scroll bar 115 is roughly ⅓ of the total scroll area, then only about ⅓ of the document is currently visible in the display area 100. Secondly, the position of the scroll bar 115 graphically represents the portion of the entire image that is within the display area 100. In other words, as shown in FIG. 1, scroll bar 115 is at the top of the scroll area 110, indicating that the beginning of the image is being displayed.

In some embodiments, the entire image to be viewed is wider than the display area 100. In such a case, a scroll area 120 is included, typically along the bottom of the display area 100. Similar to the vertical scroll area, the horizontal scroll area 120 includes a left facing arrow 121, a right facing arrow 122, and a scroll bar 125. The information that can be gleaned from the horizontal scroll area 120 is the same as that of the vertical scroll area 110, i.e. the percentage of the image that is in the display area 100, and a representation of which portion of the image is currently being displayed. In the embodiment shown in FIG. 1, the display area is roughly the size of the entire image. The image being displayed is roughly in the middle of the entire image.

The user selects the portion of the image that is shown in the display area 100 by moving the scroll bars 115,125. This can be done in a number of ways, including using the arrows 111,112,121,122, clicking on the scroll bars 115,125 and sliding them, or by clicking on a portion of the scroll area 110, 120. Other methods of moving the viewable image are also known and within the scope of the disclosure.

In some embodiments, the entire image may be text, pictures, or a combination of the two, such as a newspaper or magazine page. Using the scroll bars, the user can manipulate the image so that the entire image is eventually displayed in a way that allows the reader to logically view its contents.

For example, FIG. 2a shows the entire image 150 that is to be displayed. Note that this image is both taller than, and wider than the display area 100. In many cases, the user can position the image horizontally, using scroll bar 125 so that the margins 155 are excluded from the display area 100, but all of the content is readable. Such a configuration is shown in FIG. 2b. The entire image 150 is shown, and that portion shown in the display area 100, which is shown cross-hatched, would be visible to the user. Having resolved the horizontal size issue, the user now simply uses the vertical scroll bar 115 to move down the image until the bottom portion is visible in the display area 100.

Of course, if the image is much wider than the display area, the user may be required to constantly move the horizontal scroll bar 125 to access the image. In other cases, such as newspapers, the image may include a number of columns, such that the user reads a column from top to bottom using the vertical scroll bar 115, and then moves the horizontal scroll bar 125 to repeat the process for the next column.

In addition to navigation of a single page, there are mechanisms to navigate between pages. FIG. 3 shows a common interface used to allow users to move easily between pages of a document. Located near the display area 200 is a set of controls, including a “next page” button 210. Additionally, the controls may include one or more of the following buttons: “previous page” 212, “first page” 214 and “last page” 216. By operating these controls, the user can move forward or backward through a document. In other embodiments, the set of controls includes a user fillable field 218 that allows the user to enter a specific page number.

Obviously, the navigation schemes described above can be used in conjunction with one another. In such a scenario, the user can quickly move to a specific page and then use the scroll bars to move within the page.

More recently, touch screen devices have introduced new ways to view images on a display area. In some embodiments, the device displays a shrunken version of the image, designed to fit on the display area. The user can then expand the image in the display area by finger gestures. Similarly, the user can condense the image by an opposite finger gestures. Gestures, such as zoom-pinch, are used to provide this functionality. In addition, other finger gestures, such as swipes, can be used by the user to move the image in any direction. For example, the user may place his finger on the middle of the display area, and swipe his finger to the right. The device may interpret this gesture to indicate that the image should be moved to the right. In other words, the image currently to the left of the display area should now be placed within the display area. Other finger gestures, such as clockwise and counterclockwise spirals, have also been used to control the image shown on the display area.

Despite these various methods of manipulating the images shown in the display area, there remain issues associated with easily navigating a large document or image. It would be beneficial to develop a system and method to more easily navigate a large document or image. More specifically, it would be advantageous if a system and method were developed to automatically navigate frames on the page of a document.

### BRIEF SUMMARY OF THE INVENTION

The problems of the prior art are overcome by this system and method for navigating pages of content on a target device. The target device has a display area that is typically smaller than a page of content. Rather than having the user use scroll bars or finger gestures, a predetermined sequence of frames are displayed to the user. A frame is a preselected portion of a page. The user simply indicates when he has completed reading or viewing the current frame, and the next frame is then presented in the display area. This predetermined sequence is generated by the content provider or author, who uploads both the content and the frame sequence to a server, where it can be accessed by potential users.

### BRIEF DESCRIPTION OF THE DRAWINGS

For a better understanding of the present disclosure, reference is made to the accompanying drawings, which are incorporated herein by reference and in which:

FIG. 1 is a representation of a display area with scroll bars;

FIG. 2 is a representation of a display area and an image to displayed;

FIG. 3 is a representation of a display area and a set of controls used to control the image displayed in the display area;

FIG. 4 shows an image to be displayed.

FIG. 5 shows an image with a plurality of frames selected by the author for viewing;

FIG. 6 is a flowchart showing the sequence used by an author to establish a frame navigation sequence;

FIG. 7 is a representation of the information stored by the application; and

FIG. 8 is a representation of the file used to store frame navigation information.

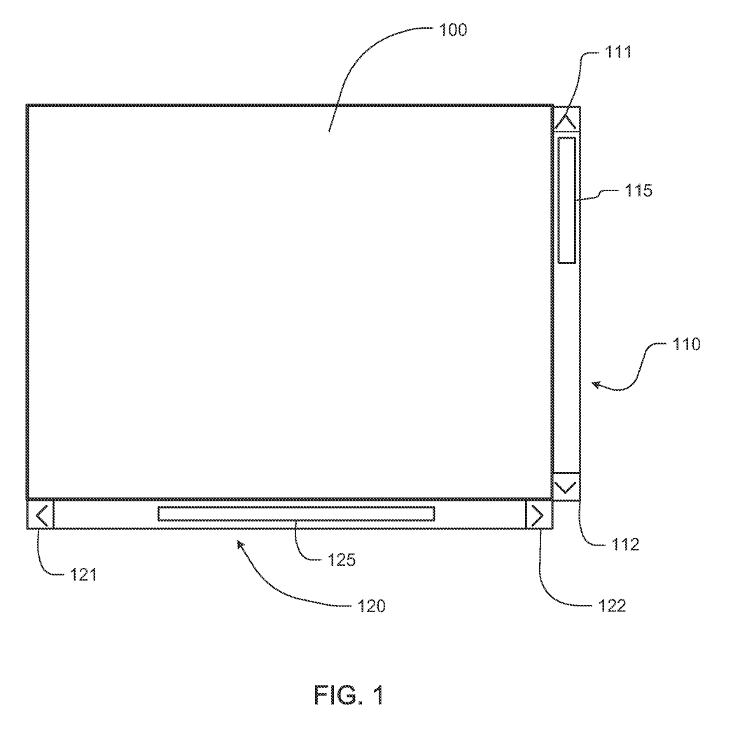

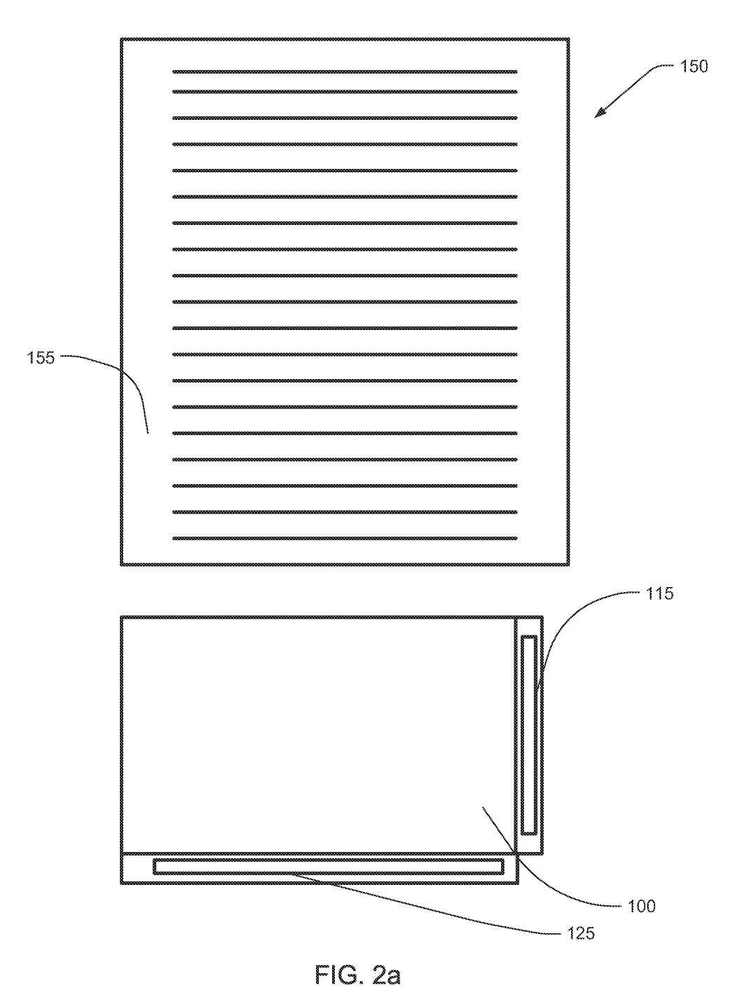

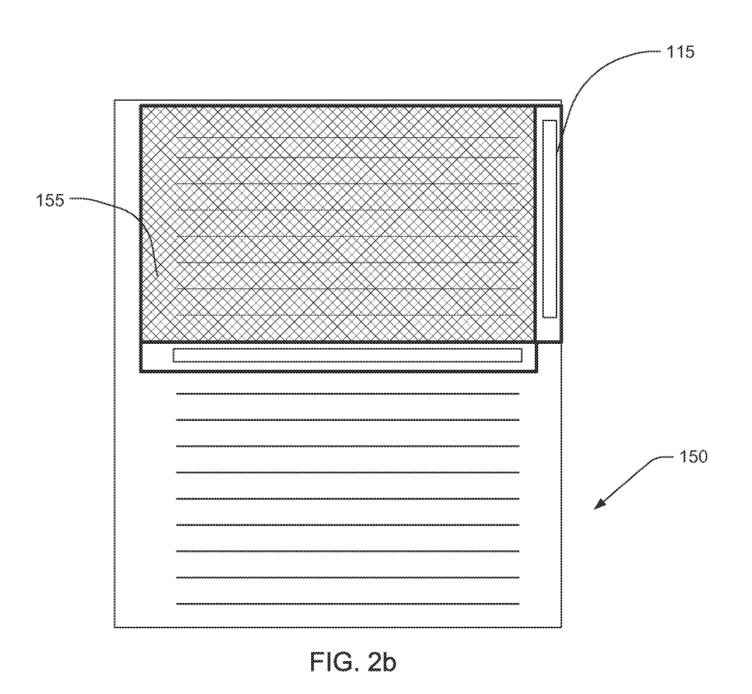

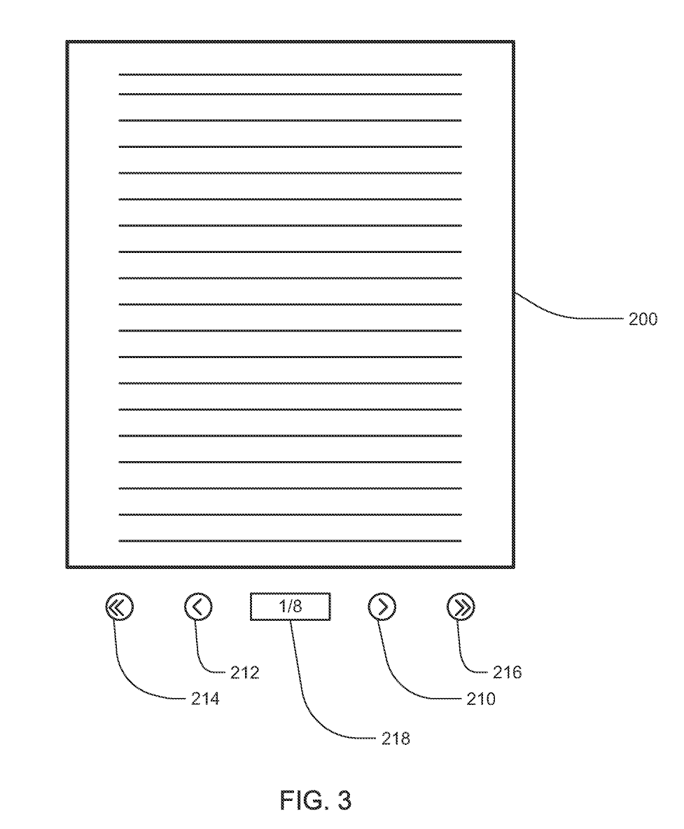

### DETAILED DESCRIPTION OF THE INVENTION

As described above, a number of methods have been employed to allow users to navigate an image to be shown in a display area. However, these methods can be awkward and clumsy, and are not ideally suited to displaying certain types of images, such as graphics or newspaper type layouts. The term “image” as used throughout this disclosure refers to a representation of any information that can be displayed on a display device. Images include graphics, pictures, text, drawings, illustrations, and any other viewable information. Although not required, in many embodiments, the image to be displayed is larger (in the horizontal direction, vertical direction, or both) than the display area on which it will be viewed.

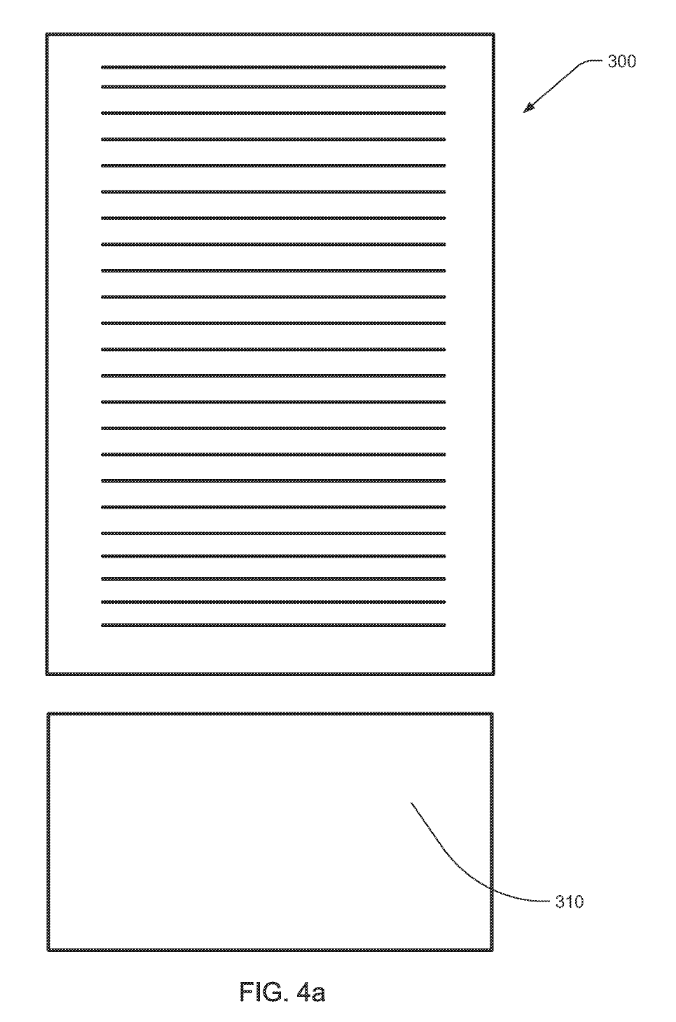

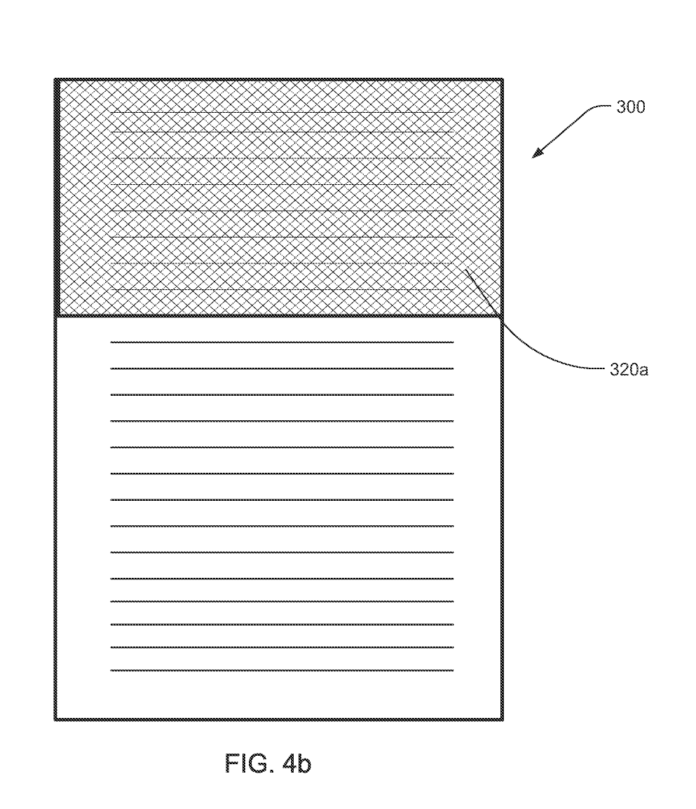

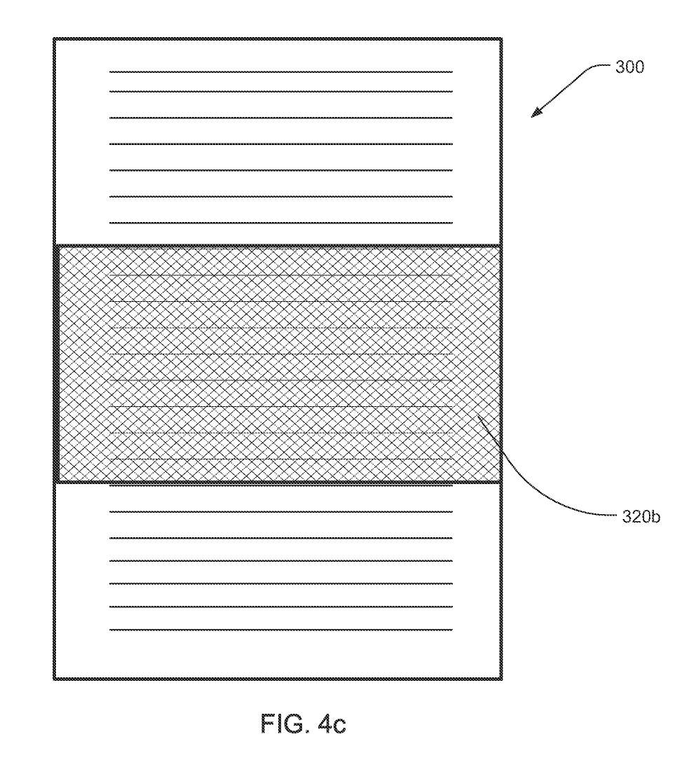

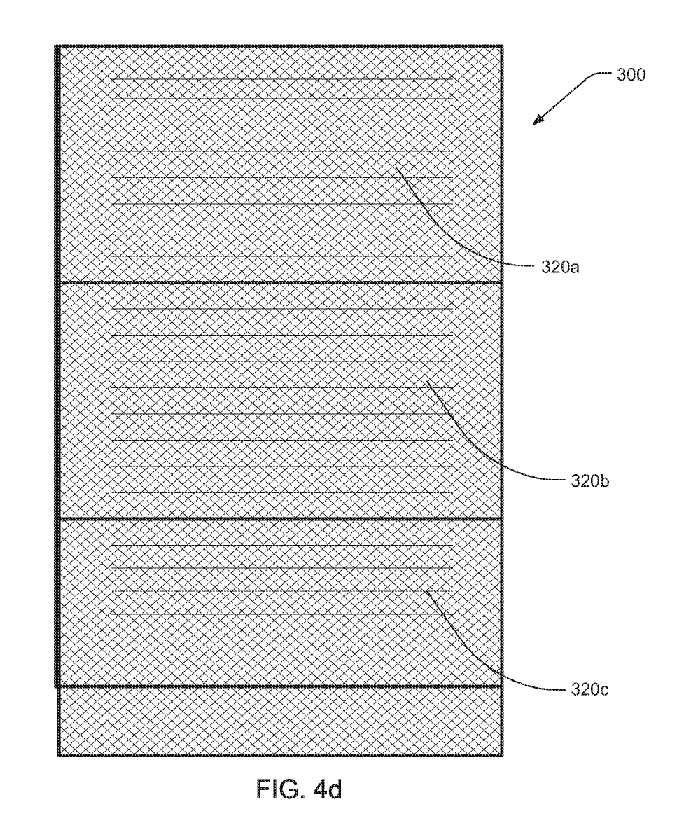

One solution to this dilemma is to allow the author, or provider, of the content to define a suitable sequence of frames that allows the user to easily navigate the image, while maintaining continuity. For example, FIG. 4a shows an image 300 that is much longer than the display area 310. Usually traditional techniques, the user would be required to use scroll bars or finger gestures (on a touch screen) to navigate the entire image.

FIG. 4b shows a first overlay 320a, where the display area 310 overlaid on the image 300. Note that only a small portion of the image 300 is visible, as shown in cross-hatching. FIG. 4c shows a second overlay 320b of image 300, also shown in cross-hatching. This overlay is contiguous to the first overlay 320a. FIG. 4d shows three overlays 320a,b,c, which when combined, comprise the entire image 300.

As stated, the author creates a suitable sequence of frame, which will be described in more detail later. Later, when the user views the image, overlay 320a is presented in the display area. After the user completes reading the displayed image, the user indicates that he wishes to move to the next frame, such as by using finger gestures, pressing a “next frame” button, or area of the display, or by using any other suitable method. The second overlay 320b is automatically displayed. Again, when the user indicates he has completed this image, the third overlay 320c is displayed. Thus, the user easily moves from overlay to overlay without undue difficulty or motions.

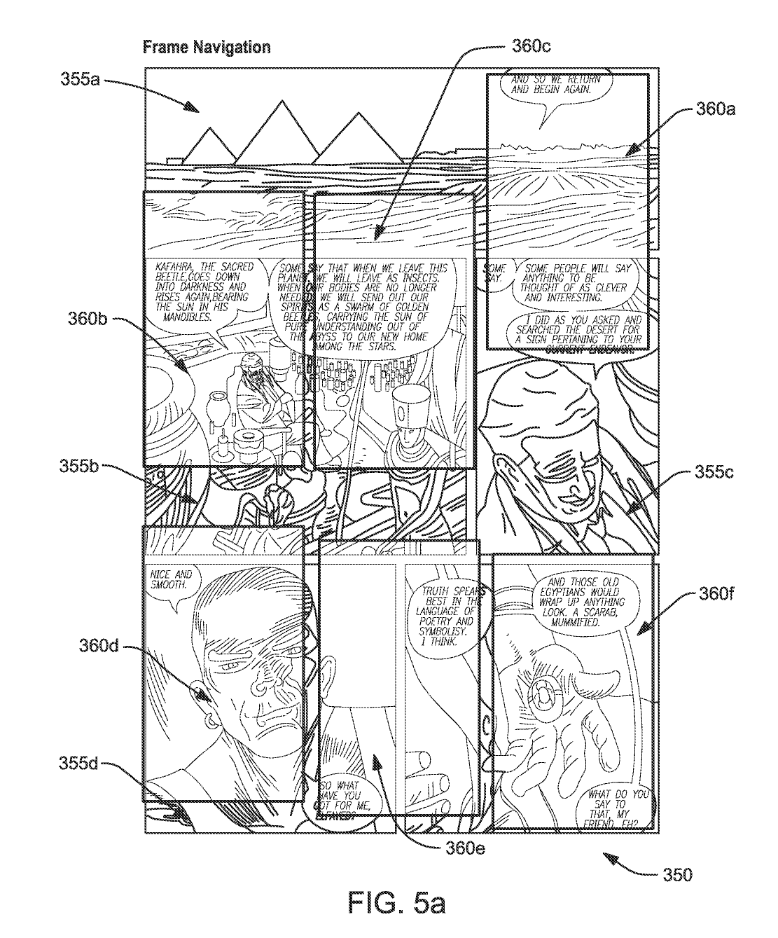

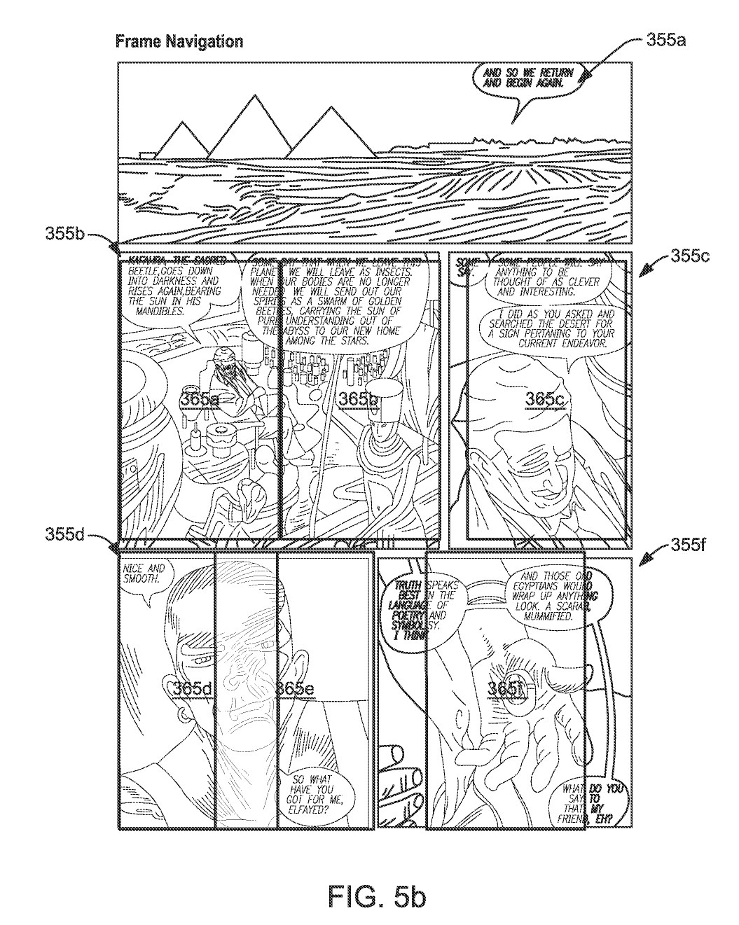

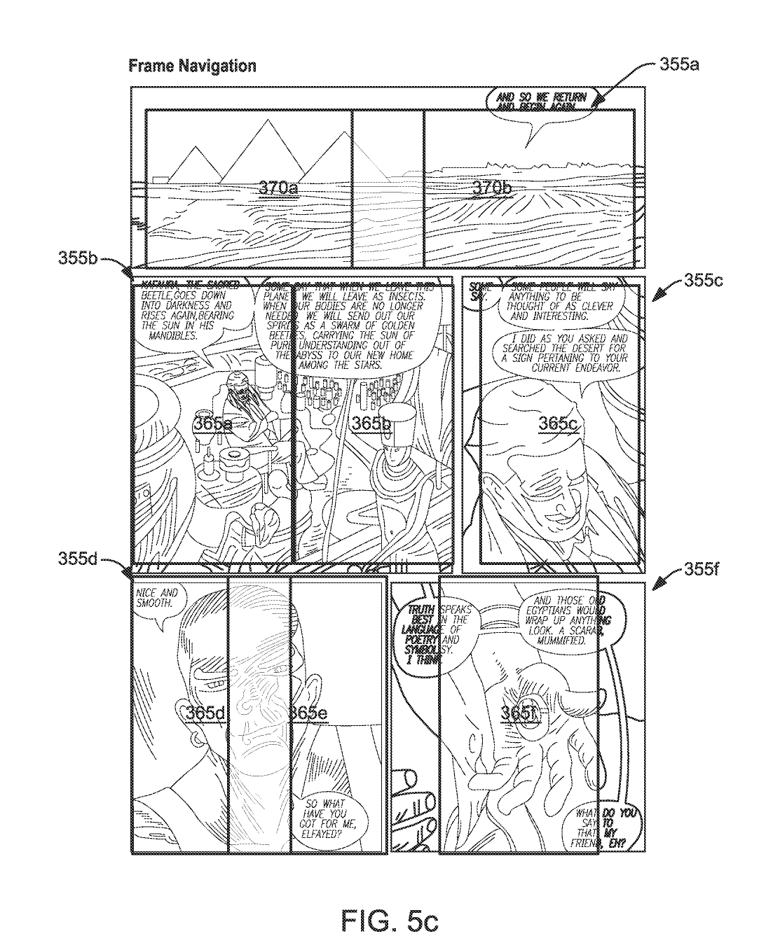

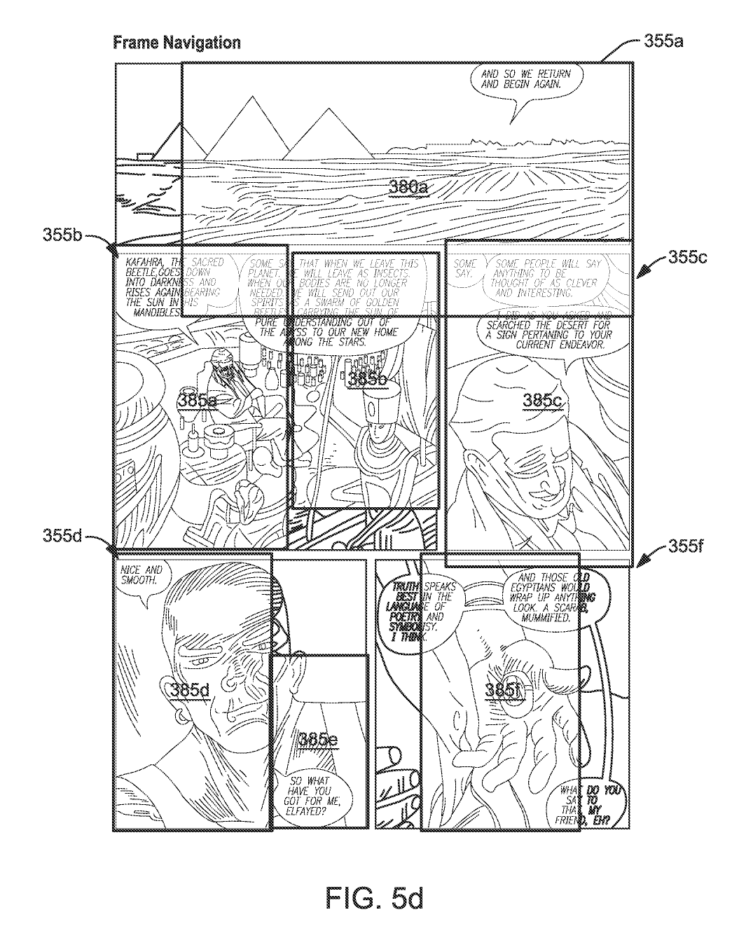

FIG. 5a shows a more complex layout 350, having a number of comic strip panels 355a-e. An associated set of overlays 360a-f can be created. Note that the totality of the overlays 360a-f need not comprise the entire image 350. In this example, large amounts of the image 350 are never made visible to the user. The user would first see the overlay 360a. The user would then see the remaining five overlays in sequential order.

Furthermore, though not shown in FIG. 5, the overlays may overlap one another. FIG. 5b shows the various comic strip panels 355a-e, with a second set of overlays 365a-f. Note that the author may choose to have two overlays 365d-e for the comic panel 355d of FIG. 5b. As the panel is smaller than two overlays, these overlays would necessarily overlap one another.

In another embodiment, the overlays may be defined in different orientations. FIG. 5c shows two additional overlays 370a-b, which are the same size as the other overlays 365a-f, however they are oriented in the transverse direction. Again, due to the size of the comic panel 355a, the two transverse overlays 370a,b overlap with one another.

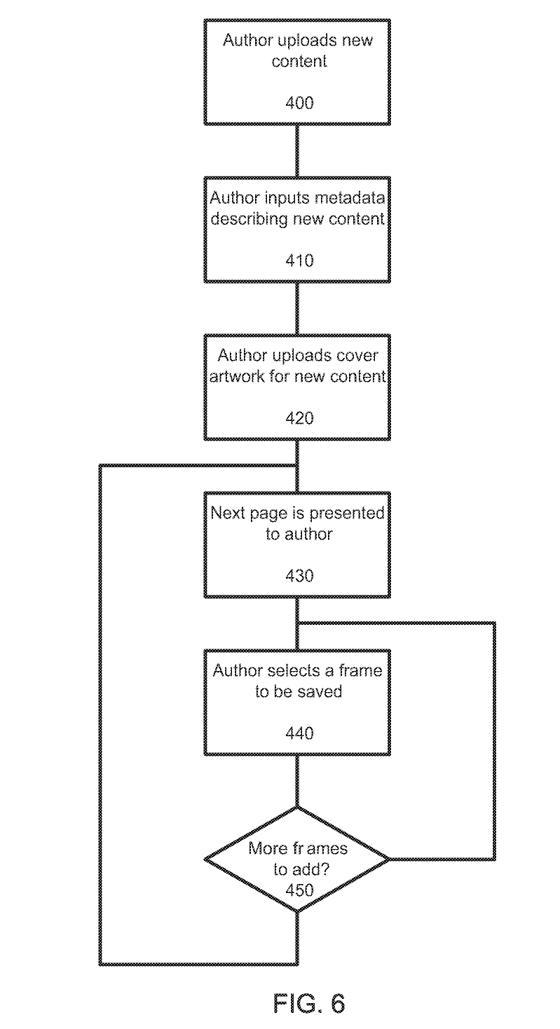

FIG. 6 shows a flowchart, illustrating the steps used by the content provider, or author, in setting up the frame navigation system. This flowchart is associated with a software program, which can be executed on any suitable platform. In one embodiment, the software is loaded into and stored on the storage device on a PC or server, where it is then executed. However, the software can be stored on any writeable storage medium, including RAM, ROM, disk drive, solid state disk drives, memory sticks, and other devices. Additionally, the software program can be executed on any suitable computing system. Furthermore, the computing system may be running any operating system, including but not limited to Unix, Linux, and Windows.

Returning to FIG. 6, in step 400, the content provider or author uploads the content or publication to a database, resident on the computing system. This content or publication can be of any type, including textual or graphical, or a combination of the two. In some embodiments, the content is comic books, which have both images and text.

Once the content has been uploaded to the database, the author may input metadata describing the new content, as shown in step 410. This metadata may include title, author's name, publication date, purchase price, number of pages, issue number, and other data. This data may be searched to help prospective users or buyers locate the content, such as by using keywords or other search parameters.

The author can then upload an image to be used as the cover for the new content in step 420. This may be a traditional book cover, or can be artwork completely disconnected from the underlying content. The uploading of content, associated metadata, and adding cover art to that content is well known, and is common in the entertainment field, such as for songs, albums, and games.

Having uploaded the content, the cover and the metadata, the author can now create the frame navigation that will be used by the user or reader. In one embodiment, the pages are presented to the author in sequential order, as shown in step 430. The page is presented in its default size. In addition to the actual page, or image, the author can view an outline or template that denotes the display area of the target user device. For example, the content may be standard letter size (8.5×11 inches), but the display area of the target device may be much smaller. In one embodiment, the target device may be an Apple iTouch, Palm Pre, Android or similar PDA having a smaller display area.

In one embodiment, the display area is fixed, as the application is intended for a specific target device. In this embodiment, the template is available to the author immediately. In other embodiments, the author may be asked to define the size (height and width), as well as the orientation (normal or transverse) of the display area. Having established the size and orientation of the display area, the author can then use this template to create a sequence of images that determine the frames and their sequence that are used for subsequent viewing by users or content purchasers. For example, as shown in step 440, the author moves the display area template to a desired location on the page or image. Once the author is satisfied with the position of the template, the author signifies his selection, such as by clicking “Save” or a similar method. This action informs the application to save the frame. The author then repeats this process as many times as desired for the current page, as shown in Decision Box 450. For example, the image shown in FIG. 5a has a total of 6 saved frames in its sequence. As explained above, the total of all frames need not be the entire page of content. In addition, frames can overlap causing portions of the page to be displayed multiple times if desired.

In another embodiment, the author is also able to specify the magnification of the frame. In other words, rather than displaying the 6 frames in their original size, as shown in FIG. 5a, the author can magnify or reduce them. For example, the author may wish to increase the amount of information shown in a frame by reducing the size of the image. In other words, this is equivalent to selecting a “zoom” setting of less than 100% in traditional software applications. This setting allows more information to be displayed, albeit at a decreased level of sharpness and precision. Alternatively, the author may wish to expand the image, or “zoom” in by selecting a magnification greater than 100%. In this case, less information is shown on the display area, however that which is shown is larger than normal. In this embodiment, the template has an aspect ratio, which is typically defined as its height divided by its width. As the magnification or “zoom” of the template is modified, the aspect ratio of the template remains fixed.

FIG. 5d shows the page of FIG. 5a, where the frame magnifications have been modified. For example, in this example, frame 380a has been zoomed out, such as by setting the magnification at 70%. Frames 385a and 385f has been unaltered, having a magnification of 100%. Frames 385b and 385e have been magnified to a setting of 120% and 140%, respectively. Frame 385c has been zoomed out so that the entire comic panel 355c is visible in the display area. This is achieved by reducing the magnification, such as to about 80%.

When creating the frame navigation sequence, the author first selects the zoom level. This can be done using a click wheel, by inputting a particular value, selecting a predetermined magnification level, using + or − keystrokes or using any other method known in the art. This action changes the effective size of the display area template, allowing the author to see how much of the image will be visible in the frame. Once the author has saved the frame, the file is updated with this information.

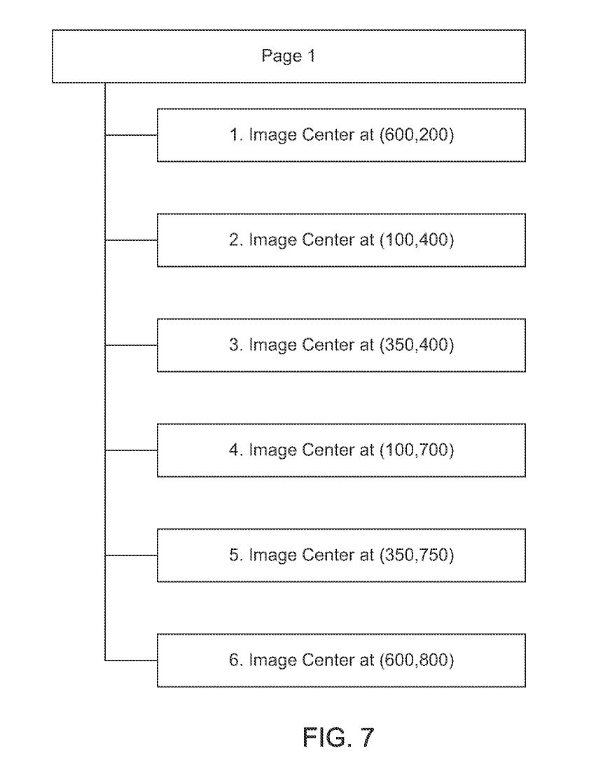

The software application saves sufficient information such that the author's intended frame sequence can be subsequently presented to the user. The information saved may include items such as the page number, the coordinates (as measured on the page) of the center or a corner of the frame, and the sequence number. FIG. 7 shows one representation of a list showing the frame navigation information associated with FIG. 5a.

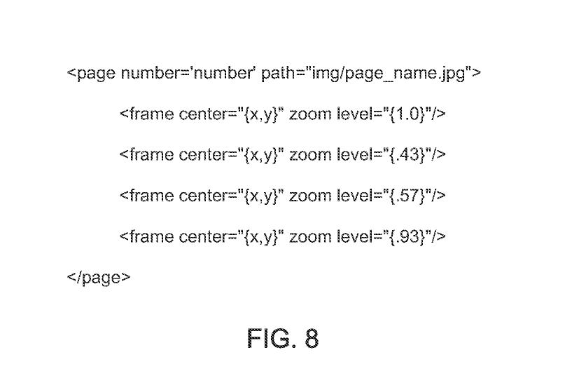

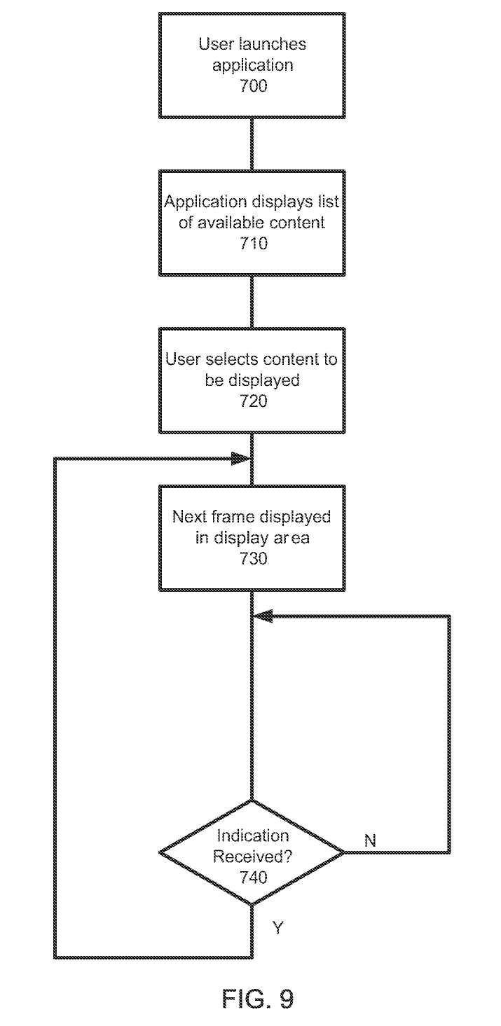

FIG. 8 shows a sample of the XML file that may be generated during the setup process. In this embodiment, all frames are associated with a page number. The processing unit of the device parses the path and name of the file that contains the image of the entire page. Once the processing unit has executed this step and located the file containing the page, it then begins the process of sequentially displaying the frames. In this example, a frame is identified by its center location, and its zoom level. The appropriate portion of the image is shown in the display area. Upon an input from the user, the processing unit then moves to the next item in the list, using its center location and zoom level. Once all of the items shown in the list have been displayed, the processing unit then moves to the next page and repeats the process.

Other algorithms can be used to store and manipulate the frame identification and sequencing information based upon platform, application needs and content restraints. For example, the software application could store the contents of each frame independently and adjust itself upon request from certain devices, rather than referring to the original content page.

Returning to FIG. 6, once the author has selected and saved all of the frames desired for a specific page, he moves onto the next page and repeats the sequence, as shown in steps 430-450. This process is repeated until the entire publication has been properly set up by the author or content provider. At this point, the setup is complete. The content, as well as the frame navigation sequence defined by the author are then saved in the database, or other storage mechanism.

In one embodiment, the author prepares the pages in sequential order. In other words, a sequence of frames is generated for page 1, followed by page 2, etc. This sequence is then repeated as the user views the content. This embodiment is common for content that is read sequentially, such as books. In another embodiment, the frames and pages may be stored in non-sequential order. For example, suppose that the content provider uploads a publication, such as a newspaper or magazine. These types of content often have links that continue on a different page. Thus, the author may set up the frame navigation such that the content is displayed such that articles are displayed from beginning to end; regardless of what page the article begins or ends on. After the entire article has been displayed, the frame navigation may return to the original page and continue on with additional news articles.

In another embodiment, a combination of conventional navigation techniques and the frame navigation described herein are used together. For example, consider the newspaper scenario. Suppose that the page of the newspaper is displayed on the user's target device, typically in a reduced size. The user, using techniques of the prior art, points to an article of interest. The act of selecting a particular article actuates the previously described frame navigation software, which then displays the article, frame by frame, as described above.

The result of this process is an output file, similar to a ZIP file. The output archive file is made up of an image directory and an XML file that is unique to that specific export or publication This file is suitable for being downloaded onto a user's target device, wherein it is then processed, defragmented, and ordered to populate all required areas of the device, such as the library, the ‘on device generated’ thumbnails, and the XML directory. For example, the XML file may be kept on a server, such as a Linux or Windows based computer. A user, who wishes to obtain the content, may then download the file to their target device. The transfer of content may require payment, however, this is not relevant to the present invention. The file is then downloaded to the target device, using one of several known mechanisms. In some embodiments, the target device has wireless (such as 802.11b) capability, and can download the file from the internet. In other embodiments, the target device is connected to a computer, using a cable or other medium. The file is then transferred from the computer to the device. Other methods of transferring data are known and within the scope of the invention.

The target device can be of various types, including Apple iTouch, PDAs, cellular telephones, tablet devices and other portable devices having some computing capability. In certain embodiments, multi-touch support is provided. In certain embodiments, multi-language support, such as but not limited to English, French, German, Japanese, Dutch, Italian, Spanish, Portuguese, Danish, Finnish, Norwegian, Swedish, Korean, Simplified Chinese, Traditional Chinese, Russian, Polish, Turkish, and Ukrainian, may be provided. In some embodiments, the device supports one or more core languages, such as, but not limited to C++, Cocoa, XML, Javascript, jQuery, HTML, and CSS.

Once the file has been downloaded to the target device, it is then decompressed, processed, & distributed to its respective linkage areas on the target device. Upon completion, the user is then able to select the downloaded file, browse selected pages, and, using the given controls, navigate the frames as described above.

FIG. 9 shows a flowchart of the steps used by the user to display the images. To view an image that has been created as described above, the user simply begins execution of the application on the target device, as shown in Box 700. In some embodiments, the user taps the screen over the icon representing the application of interest. In other embodiments, the user enters the name of the application to be executed. These and other mechanisms used to launch an application are well known in the art. Once launched, the application may ask the user to select the content to be displayed, as shown in Box 710. In some embodiments, a list of available content appears on the display area. In other embodiments, a menu showing a picture, or other graphical representation of the content, is displayed on the target device. The user selects the desired content using any of the ways commonly used, such as entering the name of a particular file, clicking (or tapping) the name or an icon representing the desired file, or any other way, as shown in Box 720. Once the desired content has been selected, the application displays the first frame of the image in the display area, as shown in Box 730. This image remains in the display area until an indication is received to advance the display to the next frame, as shown in Decision Box 740. In some embodiments, the indication may include an indication from the user, such as tapping the display area, or entering information via an input device, such as a mouse or keyboard. In other embodiments, the indication may be the expiration of a predetermined amount of time. In this mode, the images automatically sequence, much like popular slideshow-type applications.

In another embodiment, the present navigation system is combined with other prior art systems. For example, the present system can be used in conjunction with a page selector. This would allow the user to select a particular page to start the viewing. This allows the content to be viewed in multiple sittings, without having to view all of the previous images again.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A method of displaying an image in a display area of a target device, wherein said image is larger than said display area, comprising:
a. creating a predefined sequence of frames, wherein each frame comprises a portion of said image;
b. displaying a first of said frames in said display area of said target device;
c. waiting for an indication to proceed;
d. displaying a subsequent frame in said predefined sequence in response to said indication; and
e. repeating said waiting and displaying steps, until said predefined sequence is completed.

2. The method of claim 1, wherein said indication comprises a touching of said display area by said user.

3. The method of claim 1, wherein said indication comprises expiration of a predetermined amount of time.

4. The method of claim 1, wherein said creating step comprises:
i. defining a template, wherein said defined template represents the portion of said image that can be viewed in said display area;
ii. placing a first template over a first portion of said image;
iii. indicating that said first portion is to be saved as part of said sequence;
iv. saving an indication of the location of said first portion within said image;
v. placing a subsequent template over a subsequent portion of said image;
vi. indicating that said subsequent portion is to be saved as part of said sequence; and
vii. saving an indication of the location of said subsequent portion within said image.

5. A method of creating a sequence of frames, each frame comprising a portion of an image, for viewing in a display area of a target device, said method comprising:
a. defining a template, wherein said defined template represents the portion of said image that can be viewed in said display area;
b. placing a first template over a first portion of said image;
c. indicating that said first portion is to be saved as part of said sequence;
d. saving an indication of the location of said first portion within said image;
e. placing a subsequent template over a subsequent portion of said image;
f. indicating that said subsequent portion is to be saved as part of said sequence; and
g. saving an indication of the location of said subsequent portion within said image.

6. The method of claim 5, wherein said placing, indicating and saving of said subsequent portions is repeated.

7. The method of claim 5, wherein said first and subsequent templates are the same size as same defined template.

8. The method of claim 5, wherein the size of said first or said subsequent template may differ from the size of said defined template prior to said placing step.

9. The method of claim 7, wherein said defined template, said first template and said subsequent template comprise the same aspect ratio.

10. The method of claim 8, wherein said saving step also comprises saving an indication of the size of a template used.

11. The method of claim 5, wherein said indication of the location comprises the location of a specific position of said template.

12. The method of claim 11, wherein said specific position comprises the center point.

13. The method of claim 10, wherein said indication of size is related to the size of said defined template.

14. A system for creating a predetermined sequence of frames, each of said frames comprises a portion of an image, wherein said image is stored in a file, comprising:
a non-transitory computer readable medium; and computer executable instructions stored on said medium, comprising:
i. means for defining a first and second template;
ii. means for placing said first template over a first portion of said image;
iii. means for identifying the location of said first portion within said image;
iv. means for saving said location of said first portion;
v. means for placing said second template over a second portion of said image;
vi. means for identifying the location of said second portion within said image;
vii. means for saving said location of said second portion;
viii. means for creating a sequence of said saved locations; and
ix. means for iteratively displaying portions of said image, based on said created sequence.

15. The system of claim 14, further comprising means for saving the size of said first template with said location of said first portion.

16. The system of claim 14, wherein said first and second template are the same size.

17. The system of claim 14, wherein said first and second template have the same aspect ratio.
